(19) United States
(12) Patent Application Publication
(10) Pub. No.: US 2023/0206080 A1
(43) Pub. Date: Jun. 29, 2023

(54) MODEL TRAINING METHOD, SYSTEM, DEVICE, AND MEDIUM

(71) Applicant: BEIJING BAIDU NETCOM SCIENCE TECHNOLOGY CO., LTD., Beijing (CN)

(72) Inventors: Shuohuan WANG, Beijing (CN); Weibao GONG, Beijing (CN); Zhihua WU, Beijing (CN); Yu SUN, Beijing (CN); Siyu DING, Beijing (CN); Yaqian HAN, Beijing (CN); Yanbin ZHAO, Beijing (CN); Yuang LIU, Beijing (CN); Dianhai YU, Beijing (CN)

(21) Appl. No.: 18/118,339

(22) Filed: Mar. 7, 2023

(30) Foreign Application Priority Data
Apr. 6, 2022 (CN) 202210358922.4

(51) Int. Cl. G06N 3/094; G06N 3/045

(52) U.S. Cl. CPC G06N 3/094; G06N 3/045

(57) ABSTRACT

A model training system includes at least one first cluster and a second cluster communicating with the at least first cluster. The at least one first cluster is configured to acquire a sample data set, generate training data according to the sample data set, and send the training data to the second cluster; and the second cluster is configured to train a pre-trained model according to the training data sent by the at least one first cluster.

### CROSS-REFERENCE TO RELATED APPLICATION

This application claims priority to and benefits of Chinese Patent Application No. 202210358922.4, filed on Apr. 6, 2022, the entire content of which is incorporated herein by reference.

### FIELD

The present disclosure relates to the field of computer technology, in particular, to the technical fields of artificial intelligence, natural language processing, and deep learning, and especially, to a model training method, a model training system, a device, and a medium.

### BACKGROUND

With the vigorous development of computer technology, artificial intelligence technology has also developed rapidly. Medicine, finance, education and other fields are inseparable from the artificial intelligence technology. Natural language processing and deep learning technologies have also gained more and more extensive applications.

Currently, cross-cluster model training is limited by a communication bandwidth between clusters, and the efficiency of model training is low.

### SUMMARY

The present disclosure provides a model training method, a model training apparatus, a model training system, a device, a medium, and a program product.

According to an aspect of the present disclosure, there is provided a model training system. The system includes at least one first cluster and a second cluster communicating with the at least first cluster. The at least one first cluster is configured to acquire a sample data set, generate training data according to the sample data set, and send the training data to the second cluster, and the second cluster is configured to train a pre-trained model according to the training data sent by the at least one first cluster.

According to another aspect of the present disclosure, there is provided a model training method, which is applied to a first cluster communicatively connected to a second cluster. The method includes: acquiring a sample data set, generating training data according to the sample data set, and sending the training data to the second cluster for the second cluster to train a pre-trained model according to the training data.

According to another aspect of the present disclosure, there is provided a model training method, which is applied to a second cluster communicatively connected to at least one first cluster. The method includes: receiving training data sent by the at least one first cluster, and training a pre-trained model according to the training data.

According to another aspect of the present disclosure, there is provided an electronic device. The electronic device includes at least one processor, and a memory communicatively connected to the at least one processor. The memory is stored with instructions executable by the at least one processor, and the instructions, when executed by the at least one processor, cause the at least one processor to perform steps of the above-mentioned method.

According to another aspect of the present disclosure, there is provided a cluster. The cluster includes at least one processor, and a memory communicatively connected to the at least one processor. The memory is stored with instructions executable by the at least one processor, and the instructions, when executed by the at least one processor, cause the at least one processor to perform steps of the above-mentioned method.

According to another aspect of the present disclosure, there is provided a non-transitory computer-readable storage medium having stored therein computer instructions that, when executed by a computer, cause the computer to perform steps of the above-mentioned method.

It is to be understood that the content described in this section is not intended to identify key or critical features of embodiments of the present disclosure, nor is it intended to limit the scope of the present disclosure. Other features of the present disclosure will become readily understood from the following description.

### BRIEF DESCRIPTION OF THE DRAWINGS

The accompanying drawings are used for better understanding of the present disclosure, and are not restrictive of the present disclosure.

FIG. 1 is a schematic flow chart showing cross-cluster model training in a data parallel mode provided by the present disclosure.

FIG. 2 is a schematic flow chart showing cross-cluster model training in a pipeline parallel mode provided by the present disclosure.

FIG. 3 is a schematic diagram showing a model training system according to an embodiment of the present disclosure.

FIG. 4 is a schematic diagram showing a model training system according to an embodiment of the present disclosure.

FIG. 5a is a schematic flow chart showing a model training method according to an embodiment of the present disclosure.

FIG. 5b is a schematic flow chart showing a model training method according to an embodiment of the present disclosure.

FIG. 6 is a schematic flow chart showing a model training method according to an embodiment of the present disclosure.

FIG. 7 is a schematic diagram showing a model training apparatus according to an embodiment of the present disclosure.

FIG. 8 is a schematic diagram showing a model training apparatus according to an embodiment of the present disclosure.

FIG. 9 is a schematic block diagram showing an electronic device that may be used to implement embodiments of the present disclosure.

### DETAILED DESCRIPTION

Embodiments of the present disclosure are described below with reference to the accompanying drawings, which include various details of embodiments of the present disclosure to facilitate understanding, and they should be regarded as illustrative merely. Therefore, those skilled in the art will recognize that various changes and modifications may be made to embodiments described herein without departing from the scope and spirit of the present disclosure. Also, descriptions of well-known functions and structures are omitted from the following description for clarity and conciseness.

Artificial intelligence is a subject of making computers to simulate certain thinking processes and intelligent behaviors of people (such as learning, reasoning, thinking, planning, etc.), including both hardware-level technology and software-level technology. Artificial intelligence hardware technologies generally include such as sensors, dedicated artificial intelligence chips, cloud computing, distributed storage, big data processing and the like. Artificial intelligence software technologies mainly include a computer vision technology, a speech recognition technology, a natural language processing technology, a machine learning/deep learning technology, a big data processing technology, a knowledge mapping technology and others.

Natural language processing is to enable computers to process, understand and use human languages (such as Chinese, English, etc.). The natural language processing is an interdisciplinary subject of the computer science and linguistics, and is often referred to as computational linguistics. Natural language is a fundamental sign that distinguishes humans from other animals, and it is meaningless to talk about human thinking without language, so the natural language processing reflects the highest-level task and state of artificial intelligence. That is to say, only when the computer has an ability to process natural language, true intelligence is coming.

Deep learning refers to a multi-layered artificial neural network and a method for training it. A layer of neural network generally takes a large number of matrix numbers as an input, obtains weights through a nonlinear activation method, and then generates another data set as an output. Through the appropriate number of matrices, multiple layers of organizations are linked together to form a neural network “brain” for precise and complex processing, just like people identify objects and mark pictures.

In embodiments of the present disclosure, the collection, storage, use, processing, transmission, provision and disclosure of personal information of users involved therein are in compliance with relevant laws and regulations, and do not violate public order and customs.

With the vigorous development of computer technology, artificial intelligence technology has also developed rapidly. Medicine, finance, education and other fields are inseparable from artificial intelligence technology. Natural language processing technology and deep learning technology have also gained more and more extensive applications.

Currently, cross-cluster model training includes a data parallel mode and a pipeline parallel mode.

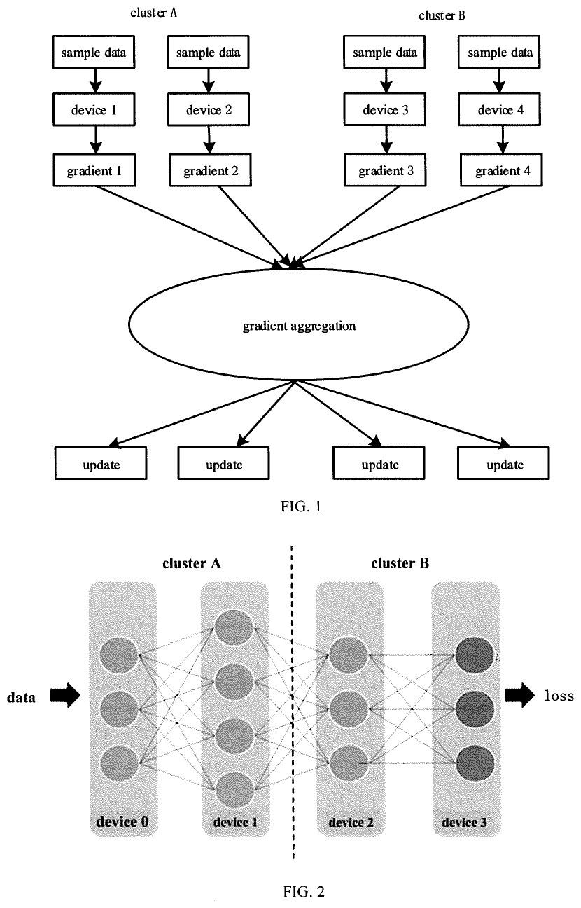

FIG. 1 is a schematic flow chart showing cross-cluster model training in a data parallel mode provided by the present disclosure. As shown in FIG. 1, a cluster A and a cluster B train a model in a data parallel mode. Multiple channels of sample data are input into multiple devices of the cluster A and the cluster B, respectively, for data training simultaneously, so that the multiple devices obtain their own gradients, respectively. The cluster A and the cluster B perform gradient aggregation on the obtained multiple gradients, and update a network parameter of the model. As shown in FIG. 1, device 1, device 2, device 3, and device 4 simultaneously perform model training on the input sample data.

FIG. 2 is a schematic flow chart showing cross-cluster model training in a pipeline parallel mode provided by the present disclosure. As shown in FIG. 2, a cluster A and a cluster B train a model in a pipeline parallel mode, and the model training task is divided into multiple subtasks in the order of computing time. The cluster A and the cluster B allocate a corresponding computing node for each subtask. As shown in FIG. 2, device 0, device 1, device 2, and device 3 are computing nodes corresponding to different subtasks.

For example, assuming that a data transmission rate between the cluster A and the cluster B is about 100 MB/s, and a model with 10 billion parameters is to be trained. If the model is trained in the data parallel mode, 100 GB of data needs to be transmitted between the clusters for each update of the model, and it takes 20 minutes to complete one time of data transmission. However, the model usually takes about 1 second for each update previously, so the training time is increased by nearly 1200 times. If the model is trained in the pipeline parallel mode, the amount of data to be transmitted between the clusters is: batch_size*sequence_length*hidden_size*2, where, as empirical values, batch_size=2048, sequence_length=1024, hidden_size=4096, and “2” means that forward and reverse communications are required. Therefore, each update needs to transmit parameters of 2048*1024*4096*2, that is, 32 GB of data needs to be transmitted each time, it takes nearly 5 minutes, and the training time is increased by nearly 300 times. As can be seen, the model training efficiency of the above-mentioned two cross-cluster model training modes is low.

To sum up, the above-mentioned cross-cluster model training methods are inefficient. In view of the above-mentioned technical problems, in some embodiments of the present disclosure, at least one first cluster trains sample data to obtain training data; and a second cluster trains a trained model according to the training data. The model for generating the training data and the pre-trained model are deployed on different clusters respectively, and cross-cluster training is performed on the model. In this way, it is only need to transmit the training data between the first cluster and the second cluster, without transmitting model parameters, so that lower-bandwidth communication between the clusters may satisfy the cross-cluster training of the present disclosure. Based on training tasks in different stages, the task of generating the training data and the task of training the pre-trained model are performed in different processors, respectively, and the model training is technically related to an internal structure of a computer system, which improves the execution effect of the hardware in the training process, and improves the processing speed of the hardware. The training data is generated by the first cluster and is provided to the second cluster for model training, which may accelerate the model training and improve the model training efficiency, as compared with the case where the training data is generated by the second cluster itself for model training.

The technical solutions provided by the embodiments of the present disclosure will be described in detail below with reference to the accompanying drawings.

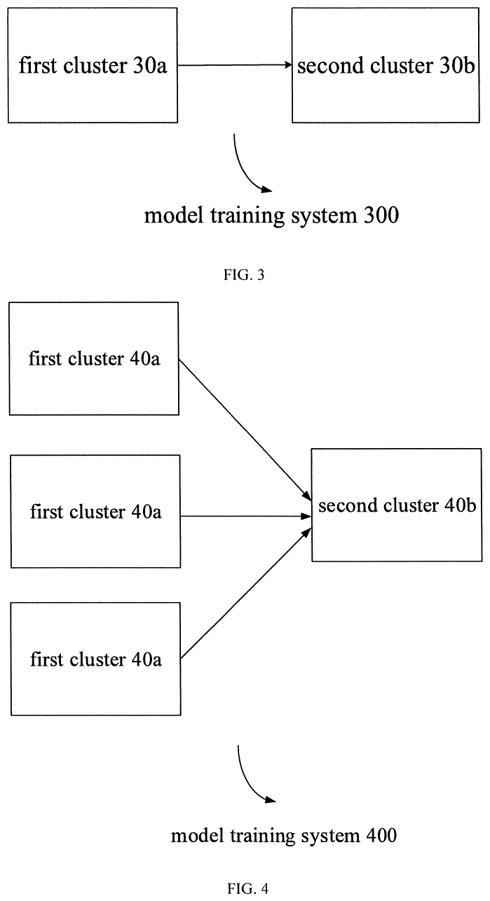

FIG. 3 is a schematic diagram showing a model training system 300 according to an embodiment of the present disclosure. As shown in FIG. 3, the model training system 300 includes a first cluster 30a and a second cluster 30b. It is to be noted that the first cluster 30a and the second cluster 30b shown in FIG. 3 are only illustrative, and do not constitute a limitation to the present disclosure. The model training system 300 may also provide other services according to actual requirements.

It is to be noted that the present disclosure does not limit the types of the first cluster 30a and the second cluster 30b, and the clusters may include storage nodes, computing nodes, and arbitration nodes, etc.

In embodiments of the present disclosure, the first cluster 30a is configured to train the sample data set to obtain training data. The second cluster 30b is configured to train the trained model according to the training data. The model for generating the training data and the pre-trained model are deployed on different clusters respectively, and cross-cluster training is performed on the model. In this way, it is only need to transmit the training data between the first cluster and the second cluster, without transmitting model parameters, so that lower-bandwidth communication between the clusters may satisfy the cross-cluster training of the present disclosure, which improves the model training efficiency.

In some embodiments, the first cluster 30a generates the training data according to the sample data set. One possible way is to input the sample data set into an initial generator to generate the training data, and train the initial generator according to the sample data set to obtain a trained generator. Correspondingly, the second cluster 30b trains the pre-trained model according to the training data sent by the first cluster 30a. One possible way is to train an initial discriminator according to the training data to obtain a trained discriminator.

In embodiments of the present disclosure, the generator and discriminator of the model in “generator+discriminator” mode are deployed on the first cluster and the second cluster, respectively, and cross-cluster training is performed on the model. In this way, it is only need to transmit training data between the first cluster and the second cluster, without transmitting model parameters, so that lower-bandwidth communication between the clusters may satisfy the cross-cluster training of the present disclosure, which improves the model training efficiency.

It is to be noted that the sample data set is a text sample data set or an image sample data set.

In some embodiments, the sample data set is a first text sample data set, a text segment in the first text sample data set is replaced with a set identifier to obtain a replaced first text sample data set, the replaced first text sample data set is input into the initial generator to obtain second text sample data, the initial discriminator is trained according to the second text sample data to obtain the trained discriminator. During the training process, the initial generator deployed in the first cluster 30a replaces part of characters, words or phrases in the first text sample data with the set identifier to generate the second text sample data, and the first cluster 30a sends the second text sample data to the second cluster 30b, the initial discriminator deployed in the second cluster 30b determines presence or not of replaced character(s), word(s) or phrase(s) in the second text sample data.

For example, the first text sample data is “Harbin is the provincial capital of Heilongjiang, an international famous city of ice and snow culture”, the initial generator deployed in the first cluster 30a replaces part of characters, words or phrases in the first text sample data with the set identifier to generate “M is the M of Heilongjiang, an international famous city of M”, and inputs “M is the M of Heilongjiang, an international famous city of M” into the generator to generate the second sample data “Mudanjiang is a city of Heilongjiang, an international famous city of ice and snow culture”. The first cluster 30a sends the second text sample data to the second cluster 30b, and the initial discriminator deployed in the second cluster 30b determines presence or not of replaced character(s), word(s) or phrase(s) in “Mudanjiang is a city of Heilongjiang, an international famous city of ice and snow culture”, with “0” indicating yes, and “1” indicating no. As a result, the discriminator determines that words such as “Mudanjiang” and “city” are replaced words.

In an embodiment, the first cluster 30a trains the initial generator according to the sample data set to obtain the trained generator. One possible way is to input an initial generation parameter into a recurrent neural network to establish the initial generator, input the sample data set into the initial generator for pre-training to obtain a pre-trained sample data set, transform the pre-trained sample data set into a probability output according to a probability distribution function to obtain a pre-trained network parameter, and update a network parameter of the initial generator according to the pre-trained network parameter to obtain the trained generator.

Correspondingly, in an embodiment, the second cluster 30b trains the initial discriminator according to the training data to obtain the trained discriminator. One possible way is to input an initial discriminant parameter into a convolutional neural network to establish the initial discriminator, input the training data into the initial discriminator for pre-training to obtain a pre-trained training data, transform the pre-trained training data into a probability output according to a probability distribution function, update the initial discriminant parameter of the initial discriminator according to a minimized cross entropy to obtain a pre-trained discriminant parameter, and update a network parameter of the initial discriminator according to the pre-trained discriminant parameter to obtain the trained discriminator.

It is to be noted that nodes inside the first cluster 30a communicate with each other via a first bandwidth, nodes inside the second cluster 30b communicate with each other via a second bandwidth, and the first cluster 30a and the second cluster 30b communicate with each other via a third bandwidth. The first bandwidth is greater than the third bandwidth, and the second bandwidth is greater than the third bandwidth. That is, the nodes inside the first cluster 30a and the second cluster 30b may maintain high-bandwidth communication, while a low bandwidth is adopted for the communication between the first cluster and the second cluster, which can completely meet the transmission of the training data without increasing any communication cost.

In embodiments of the present disclosure, training logics in the first cluster 30a and the second cluster 30b do not require to be strongly coupled, and different chips may be adopted at a bottom layer. Therefore, the first cluster 30a and the second cluster 30b are heterogeneous clusters. That is, a processor adopted by the first cluster 30a is different from a processor adopted by the second cluster 30b. In an embodiment, the processor adopted by the first cluster 30a is a graphics processor, and the processor adopted by the second cluster 30b is an embedded neural network processor.

The technical solutions of embodiments of the present disclosure are described below in combination with application scenarios.

Application Scenario 1: machine translation model. A first model deployed in the first cluster 30a generates Back-Translation data according to a text sample data set. The first cluster 30a sends the Back-Translation data to the second cluster 30b, and a second model deployed in the second cluster 30b trains the pre-trained model according to the Back-Translation data.

Application Scenario 2: multilingual pre-trained model. A first model deployed in the first cluster 30a generates Back-Translation data according to a multilingual text sample data set. The first cluster 30a sends the Back-Translation data to the second cluster 30b, and a second model deployed in the second cluster 30b trains the pre-trained model according to the Back-Translation data.

Application Scenario 3: large model distillation. A large model is deployed in the first cluster 30a, and a small model is deployed in the second cluster 30b. The first cluster 30a generates new training data when training the large model. The first cluster 30a sends the training data to the second cluster 30b, and the second cluster 30b trains the small model according to the training data.

FIG. 4 is a schematic diagram showing a model training system 400 according to an embodiment of the present disclosure. As shown in FIG. 4, the model training system 400 includes a plurality of first clusters 40a and a second cluster 40b. It is to be noted that the plurality of first clusters 40a and the second cluster 40b in FIG. 4 are only illustrative, and do not constitute a limitation to the present disclosure. The model training system 400 may also provide other services according to actual requirements.

It is to be noted that the present disclosure does not limit the types of the first cluster 40a and the second cluster 40b, and the clusters may include storage nodes, computing nodes, and arbitration nodes, etc.

In embodiments of the present disclosure, the plurality of first clusters 40a are configured to train a sample data set to obtain training data. The second cluster 40b is configured to train a trained model according to the training data. The model for generating the training data and the pre-trained model are deployed on different clusters respectively, and cross-cluster training is performed on the model. In this way, it is only need to transmit the training data between the plurality of first clusters and the second cluster, without transmitting model parameters, so that lower-bandwidth communication between the clusters may satisfy the cross-cluster training of the present disclosure, which improves the model training efficiency.

In the above-mentioned embodiments, the plurality of first clusters 40a generate the training data according to the sample data set. One possible way is that the plurality of first clusters 40a are configured to input respective sample data sets into respective initial generators to generate respective training data, and train the respective initial generators according to the respective sample data sets to obtain trained generators. Correspondingly, the second cluster 40b trains the pre-trained model according to the training data sent by the plurality of first clusters 40a. One possible way is to train an initial discriminator according to the training data to obtain a trained discriminator.

In embodiments of the present disclosure, the generators and the discriminator of the model in “a plurality of generators+a discriminator” mode are deployed on the plurality of first clusters and the second cluster, respectively, and cross-cluster training is performed on the model. In this way, it is only need to transmit the training data between the first clusters and the second cluster, without transmitting model parameters, so that lower-bandwidth communication between the clusters may satisfy the cross-cluster training of the present disclosure, which improves the model training efficiency.

It is to be noted that the sample data set is a text sample data set or an image sample data set.

In some embodiments, the sample data set is a first text sample data set. Each first cluster 40a inputs a respective first text sample data set into a respective initial generator, replaces a text segment in the first text sample data set with a set identifier to obtain respective second text sample data, and sends the respective second text sample data to the second cluster 40b. The second cluster 40b trains the initial discriminator according to the second text sample data to obtain the trained discriminator. During the training process, the initial generator deployed in each first cluster 40a generates the second text sample data after replacing a part of characters, words or phrases in the first text sample data with the set identifier, the plurality of first clusters 40a send the second text sample data to the second cluster 40b, and the initial discriminator deployed in the second cluster 40b determines presence or not of replaced character(s), word(s) or phrase(s) in the second text sample data.

For example, the first text sample data is “Harbin is the provincial capital of Heilongjiang, an international famous city of ice and snow culture”, the initial generator deployed in the first cluster 40a replaces part of characters, words or phrases in the first text sample data with the set identifier to generate “M is the M of Heilongjiang, an international famous city of M”, and inputs “M is the M of Heilongjiang, an international famous city of M” into the generator to generate the second sample data “Mudanjiang is a city of Heilongjiang, an international famous city of ice and snow culture”. The first cluster 40a sends the second text sample data to the second cluster 40b, and the initial discriminator deployed in the second cluster 40b determines presence or not of replaced character(s), word(s) or phrase(s) in “Mudanjiang is a city of Heilongjiang, an international famous city of ice and snow culture”, with “0” indicating yes, and “1” indicating no. As a result, the discriminator determines that words such as “Mudanjiang” and “city” are replaced words.

In an embodiment, each first cluster 40a trains the initial generator according to the sample data set to obtain the trained generator. One possible way is to input an initial generation parameter into a recurrent neural network to establish the initial generator, input the sample data set into the initial generator for pre-training to obtain a pre-trained sample data set, transform the pre-trained sample data set into a probability output according to a probability distribution function to obtain a pre-trained network parameter, and update a network parameter of the initial generator according to the pre-trained network parameter to obtain the trained generator.

Correspondingly, in an embodiment, the second cluster 40b trains the initial discriminator according to the training data to obtain the trained discriminator. One possible way is to input an initial discriminant parameter into a convolutional neural network to establish the initial discriminator, input the training data into the initial discriminator for pre-training to obtain a pre-trained training data, transform the pre-trained training data into a probability output according to a probability distribution function, update the initial discriminant parameter of the initial discriminator according to a minimized cross entropy to obtain a pre-trained discriminant parameter, and update a network parameter of the initial discriminator according to the pre-trained discriminant parameter to obtain the trained discriminator.

It is to be noted that nodes inside the plurality of first clusters 40a communicate with each other via a first bandwidth, nodes inside the second cluster 40b communicate with each other via a second bandwidth, and the plurality of first clusters 40a and the second cluster 40b communicate with each other via a third bandwidth. The first bandwidth is greater than the third bandwidth, and the second bandwidth is greater than the third bandwidth. That is, the nodes inside the plurality of first clusters 40a and the second cluster 40b may maintain high-bandwidth communication, while a low bandwidth is adopted for communication between the first cluster and the second cluster, which can completely meet the transmission of training data without increasing any communication cost.

It is to be noted that the types of data processed by the plurality of first clusters 40a are different. The plurality of first clusters 40a can process data in different languages, and the plurality of first clusters 40a can also process data in different industries or fields.

In embodiments of the present disclosure, the training logics in the plurality of first clusters 40a and the second cluster 40b do not require to be strongly coupled, and different chips may be adopted at a bottom layer. Therefore, the plurality of first clusters 40a and the second cluster 40b are heterogeneous clusters. That is, processors adopted by the plurality of first clusters 40a are different from a processor adopted by the second cluster 40b. In an embodiment, the processors adopted by the plurality of first clusters 40a are graphics processors, and the processor adopted by the second cluster 40b is an embedded neural network processor.

The technical solutions of embodiments of the present disclosure are described below in combination with application scenarios.

Federated Learning: models of different data types are deployed in the plurality of first clusters 40a, respectively, and a unified model of multiple data types is deployed in the second cluster 40b. For example, sample data corresponding to a cluster A, sample data corresponding to a cluster B, and sample data corresponding to a cluster C are financial sample data, medical sample data, and legal sample data, respectively. The cluster A, the cluster B, and the cluster C generate financial training data, medical training data, and legal training data according to the financial sample data, the medical sample data, and the legal sample data, respectively. A cluster D trains the unified model based on the financial training data, the medical training data, and the legal training data. Embodiments of the present disclosure achieve cross-cluster model training while protecting the security of private data.

In the above-mentioned system embodiments, the at least one first cluster trains the sample data set to obtain the training data; and the second cluster trains the trained model according to the training data. The model for generating the training data and the pre-trained model are deployed on different clusters respectively, and cross-cluster training is performed on the model. In this way, it is only need to transmit the training data between the first cluster and the second cluster, without transmitting model parameters, so that lower-bandwidth communication between the clusters may satisfy the cross-cluster training of the present disclosure. Based on training tasks in different stages, the task of generating the training data and the task of training the pre-trained model are performed in different processors, respectively, and the model training is technically related to an internal structure of a computer system, which improves the execution effect of the hardware in the training process, and improves the processing speed of the hardware. The training data is generated by the first cluster and is provided to the second cluster for model training, which may accelerate the model training and improve the model training efficiency, as compared with the case where the training data is generated by the second cluster itself for model training.

In addition to the model training system provided above, some embodiments of the present disclosure further provide a model training method. The model training method provided by embodiments of the present disclosure is not limited to the above-mentioned model training system.

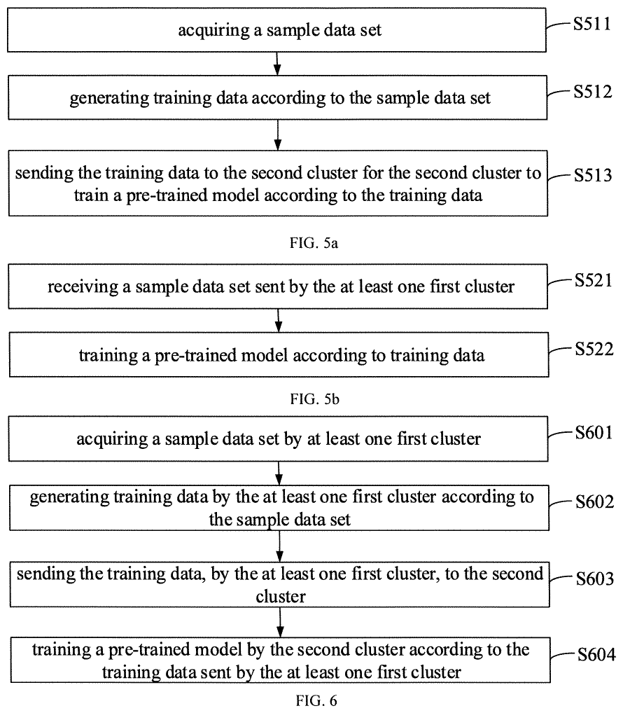

From the perspective of the first cluster, FIG. 5a is a schematic flow chart showing a model training method according to an embodiment of the present disclosure. As shown in FIG. 5a, the method includes steps S511 to S513.

In step S511, a sample data set is acquired.

In step S512, training data is generated according to the sample data set.

In step S513, the training data is sent to a second cluster for the second cluster to train a pre-trained model according to the training data.

From the perspective of the second cluster, FIG. 5b is a schematic flow chart showing a model training method according to an embodiment of the present disclosure. As shown in FIG. 5b, the method includes steps S521 and S522.

In step S521, training data sent by at least one first cluster is received.

In step S522, a pre-trained model is trained according to the training data.

In embodiments of the present disclosure, the types of the first cluster and the second cluster are not limited, and the clusters may include storage nodes, computing nodes, and arbitration nodes, etc.

It is to be noted that, the at least one first cluster may include one or more first cluster.

In embodiments of the present disclosure, the at least one first cluster is configured to train the sample data set to obtain the training data, and the second cluster is configured to train the trained model according to the training data. The model for generating the training data and the pre-trained model are deployed on different clusters respectively, and cross-cluster training is performed on the model. In this way, it is only need to transmit the training data between the first cluster and the second cluster, without transmitting model parameters, so that lower-bandwidth communication between the clusters may satisfy the cross-cluster training of the present disclosure, which improves the model training efficiency.

In the above-mentioned embodiments, the at least one first cluster generates the training data according to the sample data set. One possible way is to input the sample data set into an initial generator to generate the training data, and train the initial generator according to the sample data set to obtain a trained generator. Correspondingly, the second cluster trains the pre-trained model according to the training data sent by at least one first cluster. One possible way is to train an initial discriminator according to the training data to obtain a trained discriminator.

In embodiments of the present disclosure, the generator and the discriminator of the model in “at least one generator +discriminator” mode are deployed on the at least one first cluster and the second cluster respectively, and cross-cluster training is performed on the model. In this way, it is only need to transmit training data between the at least one first cluster and the second cluster, without transmitting model parameters, so that lower-bandwidth communication between the clusters may satisfy the cross-cluster training of the present disclosure, which improves the model training efficiency.

It is to be noted that the sample data set is a text sample data set or an image sample data set.

In some embodiments, the sample data set is a first text sample data set, a text segment in the first text sample data set is replaced with a set identifier to obtain a replaced first text sample data set, the replaced first text sample data set is input into the initial generator to obtain second text sample data, and the initial discriminator is trained according to the second text sample data to obtain the trained discriminator. During the training process, the initial generator deployed in the at least one first cluster generates at least one second text sample data after replacing part of characters, words or phrases in the first text sample data with the set identifier, the at least one first cluster sends the second text sample data to the second cluster, and the initial discriminator deployed in the second cluster determines presence or not of replaced character(s), word(s) or phrase(s) in the second text sample data.

For example, the first text sample data is “Harbin is the provincial capital of Heilongjiang, an international famous city of ice and snow culture”, the initial generator deployed in the first cluster replaces part of characters, words or phrases in the first text sample data with the set identifier to generate “M is the M of Heilongjiang, an international famous city of M”, and inputs “M is the M of Heilongjiang, an international famous city of M” into the generator to generate second sample data “Mudanjiang is a city of Heilongjiang, an international famous city of ice and snow culture”. The first cluster sends the second text sample data to the second cluster, and the initial discriminator deployed in the second cluster determines presence or not of replaced character(s), word(s) or phrase(s) in “Mudanjiang is a city of Heilongjiang, an international famous city of ice and snow culture”, with “0” indicating yes, and “1” indicating no. As a result, the discriminator determines that words such as “Mudanjiang” and “city” are the replaced words.

In an embodiment, each first cluster trains the initial generator according to the sample data set to obtain the trained generator. One possible way is to input an initial generation parameter into a recurrent neural network to establish the initial generator, input the sample data set into the initial generator for pre-training to obtain a pre-trained sample data set, transform the pre-trained sample data set into a probability output according to a probability distribution function to obtain a pre-trained network parameter, and update a network parameter of the initial generator according to the pre-trained network parameter to obtain the trained generator.

Correspondingly, in an embodiment, the second cluster trains the initial discriminator according to the training data to obtain the trained discriminator. One possible way is to input an initial discriminant parameter into a convolutional neural network to establish the initial discriminator, input the training data into the initial discriminator for pre-training to obtain a pre-trained training data, transform the pre-trained training data into a probability output according to a probability distribution function, update the initial discriminant parameter of the initial discriminator according to a minimized cross entropy to obtain a pre-trained discriminant parameter, and update a network parameter of the initial discriminator according to the pre-trained discriminant parameter to obtain the trained discriminator.

It is to be noted that nodes inside the first cluster communicate with each other via a first bandwidth, nodes inside the second cluster communicate with each other via a second bandwidth, and the first cluster and the second cluster communicate with each other via a third bandwidth. The first bandwidth is greater than the third bandwidth, and the second bandwidth is greater than the third bandwidth. That is, the nodes inside the first cluster and the second cluster may maintain high-bandwidth communication, and a low bandwidth is adopted for communication between the first cluster and the second cluster, which can completely meet the transmission of training data without increasing any communication cost.

In embodiments of the present disclosure, the training logics in the at least one first cluster and the second cluster do not require to be strongly coupled, and different chips may be adopted at a bottom layer. Therefore, the at least one first cluster and the second cluster 30b are heterogeneous clusters. That is, a processor adopted by the at least one first cluster is different from a processor adopted by the second cluster. In an embodiment, the processor adopted by the at least one first cluster is a graphics processor, and the processor adopted by the second cluster is an embedded neural network processor.

It is to be noted that the types of data processed by a plurality of first clusters are different. The plurality of first clusters may process data in different languages, and the plurality of first clusters may also process data in different industries or fields.

The technical solutions of embodiments of the present disclosure are described below in combination with application scenarios.

Application Scenario 1: machine translation model. A first model deployed in the first cluster generates Back-Translation data according to a text sample data set. The first cluster sends the Back-Translation data to the second cluster, and a second model deployed in the second cluster trains the pre-trained model according to the Back-Translation data.

Application Scenario 2: multilingual pre-trained model. A first model deployed in the first cluster generates Back-Translation data according to a multilingual text sample data set. The first cluster sends the Back-Translation data to the second cluster, and a second model deployed in the second cluster trains the pre-trained model according to the Back-Translation data.

Application Scenario 3: large model distillation. A large model is deployed in the first cluster, and a small model is deployed in the second cluster. The first cluster generates new training data when training the large model. The first cluster sends the training data to the second cluster, and the second cluster trains the small model according to the training data.

Application Scenario 4: federated learning. Models of different data types are deployed in the plurality of first clusters 40a, respectively, and a unified model of multiple data types is deployed in the second cluster 40b. For example, sample data corresponding to a cluster A, sample data corresponding to a cluster B, and sample data corresponding to a cluster C are financial sample data, medical sample data, and legal sample data, respectively. The cluster A, the cluster B, and the cluster C generate financial training data, medical training data, and legal training data according to the financial sample data, the medical sample data, and the legal sample data. A cluster D trains the unified model based on the financial training data, the medical training data, and the legal training data. Embodiments of the present disclosure achieve cross-cluster model training while protecting the security of private data.

Based on the descriptions of the above embodiments, FIG. 6 provides a schematic flow chart showing a model training method according to an embodiment of the present disclosure. As shown in FIG. 6, the method includes step S601 to S604.

In step S601, at least one first cluster acquires a sample data set.

In step S602, the at least one first cluster generates training data according to the sample data set.

In step S603, the at least one first cluster sends the training data to a second cluster.

In step S604, the second cluster trains a pre-trained model according to the training data sent by the at least one first cluster.

In embodiments of the present disclosure, the types of the first cluster and the second cluster are not limited, and the clusters may include storage nodes, computing nodes, and arbitration nodes, etc.

It is to be noted that, for the implementation of each step in embodiments of the present disclosure, reference may be made to the descriptions of the corresponding parts in the above-mentioned embodiments, which will not be elaborated herein.

In the above-mentioned method embodiments, the at least one first cluster trains the sample data set to obtain the training data; and the second cluster trains the trained model according to the training data. The model for generating the training data and the pre-trained model are deployed on different clusters respectively, and cross-cluster training is performed on the model. In this way, it is only need to transmit the training data between the first cluster and the second cluster, without transmitting model parameters, so that lower-bandwidth communication between the clusters may satisfy the cross-cluster training of the present disclosure. Based on training tasks in different stages, the task of generating the training data and the task of training the pre-trained model are performed in different processors, respectively, and the model training is technically related to an internal structure of a computer system, which improves the execution effect of the hardware in the training process, and improves the processing speed of the hardware. The training data is generated by the first cluster and is provided to the second cluster for model training, which may accelerate the model training and improve the model training efficiency, as compared with the case where the training data is generated by the second cluster itself for model training.

FIG. 7 is a schematic diagram showing a model training apparatus 70 according to an embodiment of the present disclosure. The model training apparatus 70 includes an acquiring module 71, a generating module 72, and a sending module 73.

The acquiring module 71 is configured to acquire a sample data set.

The generating module 72 is configured to generate training data according to the sample data set.

The sending module 73 is configured to send the training data to the second cluster for the second cluster to train a pre-trained model according to the training data.

In some embodiments, the generating module 72, when generating the training data according to the sample data set, is configured to input the sample data set into an initial generator to generate the training data, and train the initial generator according to the sample data set to obtain a trained generator.

In some embodiments, the sample data set is a first text sample data set, and the generating module 72, when inputting the sample data set into the initial generator to generate the training data, is configured to replace a text segment in the first text sample data set with a set identifier to obtain a replaced first text sample data set, and input the replaced first text sample data set into the initial generator to obtain second text sample data.

In some embodiments, the generating module 72, when training the initial generator according to the sample data set to obtain the trained generator, is configured to input an initial generation parameter into a recurrent neural network to establish the initial generator, input the sample data set into the initial generator for pre-training to obtain a pre-trained sample data set, transform the pre-trained sample data set into a probability output according to a probability distribution function to obtain a pre-trained network parameter, and update a network parameter of the initial generator according to the pre-trained network parameter to obtain the trained generator.

In some embodiments, nodes inside the first cluster communicate with each other via a first bandwidth, nodes inside the second cluster communicate with each other via a second bandwidth, and the first cluster and the second cluster communicate with each other via a third bandwidth. The first bandwidth is greater than the third bandwidth, and the second bandwidth is greater than the third bandwidth.

In some embodiments, the at least one first cluster and the second cluster are heterogeneous clusters.

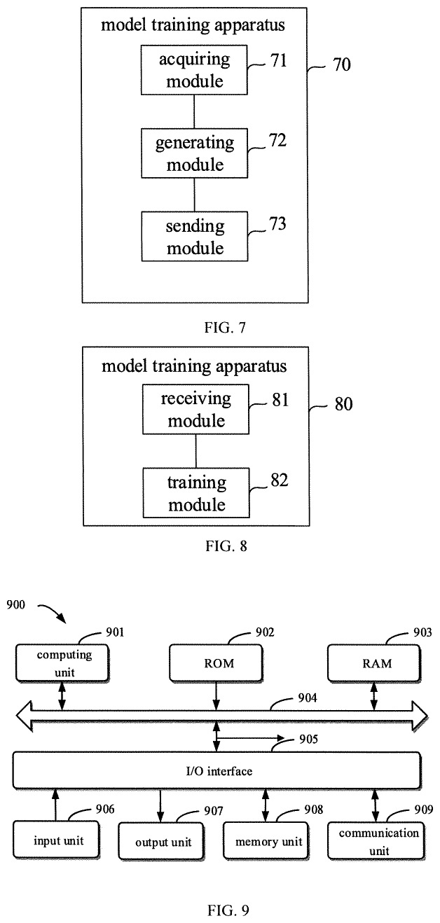

FIG. 8 is a schematic diagram showing a model training apparatus 80 according to an embodiment of the present disclosure. The model training apparatus 80 includes a receiving module 81 and a training module 82.

The receiving module 81 is configured to receive training data sent by the at least one first cluster.

The training module 82 is configured to train a pre-trained model according to the training data.

In some embodiments, the training module 82, when training the pre-trained model according to the training data, is configured to train an initial discriminator according to the training data to obtain a trained discriminator.

In some embodiments, the training data is a second text sample data, and the training module 82, when training the initial discriminator according to the training data to obtain the trained discriminator, is configured to train the initial discriminator according to the second text sample data to obtain the trained discriminator.

In some embodiments, the training module 82, when training the initial discriminator according to the training data to obtain the trained discriminator, is configured to input an initial discriminant parameter into a convolutional neural network to establish the initial discriminator, input the training data into the initial discriminator for pre-training to obtain a pre-trained training data, transform the pre-trained training data into a probability output according to a probability distribution function, update the initial discriminant parameter of the initial discriminator according to a minimized cross entropy to obtain a pre-trained discriminant parameter, and update a network parameter of the initial discriminator according to the pre-trained discriminant parameter to obtain the trained discriminator.

According to embodiments of the present disclosure, the present disclosure further provides an electronic device, a readable storage medium, and a computer program product.

In some embodiments of the present disclosure, there is provided a computer program product including a computer program that, when executed by a processor, causes the processor to implement steps of the above-mentioned method.

With respect to the apparatus in the above embodiments, the specific manners of individual modules for performing operations have been described in detail in the embodiments regarding the methods, which will not be elaborated herein.

FIG. 9 is a block diagram showing an electronic device 900 that may be used to implement embodiments of the present disclosure. The electronic device is intended to represent various forms of digital computers, such as, a laptop computer, a desktop computer, a workstation, a personal digital assistant, a server, a blade server, a mainframe computer, and other suitable computers. The electronic device may also represent various forms of mobile device, such as a personal digital processor, a cellular phone, a smart phone, a wearable device, and other similar computing devices. Components shown herein, their connections and relationships, and their functions are only illustrative, and are not intended to limit the implementations of the present disclosure described and/or claimed herein.

As shown in FIG. 9, the electronic device 900 includes a computing unit 901 that can perform various appropriate actions and processes according to a computer program stored in a read-only memory (ROM) 902 or loaded from a memory unit 908 into a random access memory (RAM) 903. In the RAM 903, various programs and data required for the operation of the device 900 may also be stored. The computing unit 901, the ROM 902, and the RAM 903 are connected to each other via a bus 904. An input/output (I/O) interface 905 is also connected to the bus 904.

A plurality of components in the electronic device 900 are connected to the I/O interface 905, including an input unit 906, such as a keyboard, and a mouse; an output unit 907, such as various types of displays, and speakers; the memory unit 908, such as a magnetic disk, and an optical disk; and a communication unit 909, such as a network card, a modulator-demodulator, and a wireless communication transceiver. The communication unit 909 allows the electronic device 900 to exchange information/data with other devices via a computer network such as Internet and/or various telecommunications networks.

The computing unit 901 may be various generic and/or specific processing assemblies with processing and computational capabilities. Some examples of the computing unit 901 include, but are not limited to, central processing units (CPUs), graphics processing units (GPUs), various specific artificial intelligence (AI) computing chips, various computing units that run machine learning model algorithms, digital signal processors (DSPs), and any appropriate processors, controllers, and microcontrollers. The computing unit 901 is configured to execute the various methods and processes described above, for example the model training method. For example, in some embodiments, the model training method may be implemented as a computer software program that is tangibly embodied on a machine-readable medium, such as the memory unit 908. In some embodiments, part or all of computer programs may be loaded and/or installed on the electronic device 900 via the ROM 902 and/or the communication unit 909. When a computer program is loaded into the RAM 903 and executed by the computing unit 901, one or more steps of the model training method described above may be executed. Alternatively, in other embodiments, the computing unit 901 may be configured to execute the model training method by any other suitable means (e.g., by means of a firmware).

Various implementations of the systems and techniques above-described herein may be implemented in digital electronic circuit systems, integrated circuit systems, field programmable gate arrays (FPGAs), application specific integrated circuits (ASICs), application specific standard products (ASSPs), system-on-chip (SOC) systems, load programmable logic devices (CPLDs), computer hardware, firmware, software, and/or combinations thereof. These various embodiments may include being implemented in one or more computer programs executable and/or interpretable on a programmable system including at least one programmable processor. The programmable processor may be a specific or generic programmable processor that may receive data and instructions from a storage system, at least one input device, and at least one output device, and transmit data and instructions to the storage system, the at least one input device, and the at least one output device.

Program codes for implementing the method in embodiments of the present disclosure may be written in one or more programming languages in any combination. These program codes may be provided to a processor or a controller of a generic computer, a specific computer or other programmable data processing devices, such that the program codes, when executed by the processor or the controller, causes the functions/operations specified in the flowcharts and/or block diagrams to be implemented. The program codes may be entirely executed on a machine, partly executed on the machine, partly executed on the machine and partly executed on a remote machine as a stand-alone software package, or entirely executed on the remote machine or a server.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), a fiber optic, a portable compact disk read only memory (CD-ROM), an optical storage device, a magnetic storage device, or any suitable combination of the foregoing.

To provide interaction with a user, the systems and techniques described herein may be implemented on a computer having a display apparatus (e.g., a cathode ray tube (CRT) or a liquid crystal display (LCD) monitor) for displaying information to the user; and a keyboard and a pointing apparatus (e.g., a mouse or a trackball) through which the user can provide an input to the computer. Other kinds of apparatuses can also be used to provide interaction with the user; for example, a feedback provided to the user can be any form of sensory feedback (e.g., a visual feedback, an auditory feedback, or a tactile feedback); and the input from the user may be received in any form (including acoustic input, voice input, or tactile input).

The systems and techniques described herein can be implemented in a computing system including a back-end component (e.g., as a data server), a computing system including a middleware component (e.g., an application server), a computing system including a front-end component (e.g., a user computer having a graphical user interface or a web browser through which a user may interact with implementations of the systems and techniques described herein), or a computing system that includes any combination of the back-end component, the middleware component, or the front-end component. The components of the system may be connected with each other via any form or medium of digital data communication (e.g., a communication network). An example of the communication network includes a local area network (LAN), a wide area network (WAN), Internet, and a blockchain network.

The computer system may include a client and a server. The client and the server are generally remote from each other and usually interact with each other through a communication network. A relationship of the client and the server is generated by a computer program that runs on a corresponding computer and has a client-server relationship with each other. The server may be a cloud server, also referred to as a cloud computing server or a cloud host, which is a host product in a cloud computing service system, so as to solve defects of a traditional physical host and a VPS service (“Virtual Private Server”, or abbreviated as “VPS”), such as difficult management and weak business scalability. The server may also be a server for a distributed system, or a server combined with a blockchain.

In embodiments of the above-mentioned method, apparatus, device, storage medium, and computer program product, the at least one first cluster trains the sample data set to obtain the training data; and the second cluster trains the trained model according to the training data. The model for generating the training data and the pre-trained model are deployed on different clusters respectively, and cross-cluster training is performed on the model. In this way, it is only need to transmit the training data between the first cluster and the second cluster, without transmitting model parameters, so that lower-bandwidth communication between the clusters may satisfy the cross-cluster training of the present disclosure. Based on training tasks in different stages, the task of generating the training data and the task of training the pre-trained model are performed in different processors, respectively, and the model training is technically related to an internal structure of a computer system, which improves the execution effect of the hardware in the training process, and improves the processing speed of the hardware. The training data is generated by the first cluster and is provided to the second cluster for model training, which may accelerate the model training and improve the model training efficiency, as compared with the case where the training data is generated by the second cluster itself for model training.

It can be understood that various forms of flow charts shown above can be used to reorder, add, or remove steps. For example, the steps described in the present disclosure may be performed in parallel, sequentially, or in a different order. There is no limitation herein as long as the desired results of the technical solutions disclosed herein can be realized.

The above-mentioned specific embodiments do not constitute a limitation on the protection scope of the present disclosure. It can be understood by those skilled in the art that various modifications, combinations, sub-combinations and substitutions can be made depending on design requirements and other factors. Any modifications, equivalent replacements, and improvements made within the spirit and principle of the present disclosure can be included within the protection scope of the present disclosure.

What is claimed is:

1. A model training system, comprising at least one first cluster and a second cluster communicating with the at least first cluster, wherein:
the at least one first cluster is configured to acquire a sample data set, generate training data according to the sample data set, and send the training data to the second cluster; and
the second cluster is configured to train a pre-trained model according to the training data sent by the at least one first cluster.

2. The system of claim 1, wherein nodes inside the at least one first cluster communicate with each other via a first bandwidth, nodes inside the second cluster communicate with each other via a second bandwidth, and the at least one first cluster and the second cluster communicate with each other via a third bandwidth, wherein the first bandwidth is greater than the third bandwidth, and the second bandwidth is greater than the third bandwidth.

3. The system of claim 1, wherein the at least one first cluster and the second cluster are heterogeneous clusters.

4. The system of claim 3, wherein a processor adopted by the at least one first cluster is different from a processor adopted by the second cluster.

5. The system of claim 4, wherein the processor adopted by the at least one first cluster is a graphics processor, and the processor adopted by the second cluster is an embedded neural network processor.

6. The system of claim 1, wherein the at least one first cluster comprises a plurality of first clusters, and data types processed by the plurality of first clusters are different.

7. The system of claim 1, wherein the at least one first cluster is configured to:
input the sample data set into an initial generator to generate the training data, and train the initial generator according to the sample data set to obtain a trained generator; and
wherein the second cluster, when training the pre-trained model according to the training data sent by the at least one first cluster, is configured to:
train an initial discriminator according to the training data to obtain a trained discriminator.

8. The system of claim 7, wherein the sample data set is a first text sample data set, and the at least one first cluster is configured to:
replace a text segment in the first text sample data set with a set identifier to obtain a replaced first text sample data set, and input the replaced first text sample data set into the initial generator to obtain second text sample data; and
the second cluster, when training the initial discriminator according to the training data to obtain the trained discriminator, is configured to:
train the initial discriminator according to the second text sample data to obtain the trained discriminator.

9. The system of claim 7, wherein the at least one first cluster is configured to:
input an initial generation parameter into a recurrent neural network to establish the initial generator;
input the sample data set into the initial generator for pre-training to obtain a pre-trained sample data set;
transform the pre-trained sample data set into a probability output according to a probability distribution function to obtain a pre-trained network parameter; and
update a network parameter of the initial generator according to the pre-trained network parameter to obtain the trained generator.

10. The system of claim 7, wherein the second cluster is configured to:
input an initial discriminant parameter into a convolutional neural network to establish the initial discriminator;
input the training data into the initial discriminator for pre-training to obtain a pre-trained training data;
transform the pre-trained training data into a probability output according to a probability distribution function;
update the initial discriminant parameter of the initial discriminator according to a minimized cross entropy to obtain a pre-trained discriminant parameter; and
update a network parameter of the initial discriminator according to the pre-trained discriminant parameter to obtain the trained discriminator.

11. A model training method, performed by a first cluster communicatively connected to a second cluster, comprising:
acquiring a sample data set;
generating training data according to the sample data set; and
sending the training data to the second cluster for the second cluster to train a pre-trained model according to the training data.

12. The method of claim 11, wherein generating the training data according to the sample data set comprises:
inputting the sample data set into an initial generator to generate the training data, and training the initial generator according to the sample data set to obtain a trained generator.

13. The method of claim 12, wherein the sample data set is a first text sample data set, and inputting the sample data set into the initial generator to generate the training data comprises:
replacing a text segment in the first text sample data set with a set identifier to obtain a replaced first text sample data set, and
inputting the replaced first text sample data set into the initial generator to obtain second text sample data,
wherein training the initial generator according to the sample data set to obtain the trained generator comprises:
inputting an initial generation parameter into a recurrent neural network to establish the initial generator;
inputting the sample data set into the initial generator for pre-training to obtain a pre-trained sample data set;
transforming the pre-trained sample data set into a probability output according to a probability distribution function to obtain a pre-trained network parameter; and
updating a network parameter of the initial generator according to the pre-trained network parameter to obtain the trained generator.

14. A model training method, performed by a second cluster communicatively connected to at least one first cluster, comprising:
receiving training data sent by the at least one first cluster; and
training a pre-trained model according to the training data.

15. The method of claim 14, wherein training the pre-trained model according to the training data comprises:
training an initial discriminator according to the training data to obtain a trained discriminator.

16. The method of claim 15, wherein the training data is second text sample data, and training the initial discriminator according to the training data to obtain the trained discriminator comprises:
training the initial discriminator according to the second text sample data to obtain the trained discriminator; or
wherein training the initial discriminator according to the training data to obtain the trained discriminator comprises:
inputting an initial discriminant parameter into a convolutional neural network to establish the initial discriminator;
inputting the training data into the initial discriminator for pre-training to obtain a pre-trained training data;
transforming the pre-trained training data into a probability output according to a probability distribution function;
updating the initial discriminant parameter of the initial discriminator according to a minimized cross entropy to obtain a pre-trained discriminant parameter; and
updating a network parameter of the initial discriminator according to the pre-trained discriminant parameter to obtain the trained discriminator.

17. An electronic device, comprising:
at least one processor; and
a memory communicatively connected to the at least one processor; wherein
the memory is stored with instructions executable by the at least one processor, and the instructions, when executed by the at least one processor, cause the at least one processor to perform steps of the method of claim 11.

18. A non-transitory computer-readable storage medium having stored therein computer instructions that, when executed by a computer, cause the computer to perform steps of the method of claim 11.

19. An electronic device, comprising:
at least one processor; and
a memory communicatively connected to the at least one processor; wherein
the memory is stored with instructions executable by the at least one processor, and the instructions, when executed by the at least one processor, cause the at least one processor to perform steps of the method of claim 14.

20. A non-transitory computer-readable storage medium having stored therein computer instructions that, when executed by a computer, cause the computer to perform steps of the method of claim 14.
